(19) United States
(12) Patent Application Publication
(10) Pub. No.: US 2004/0062868 A1
(43) Pub. Date: Apr. 1, 2004

(54) Device and process for impregnating a paper or cardboard web

(75) Inventors: Rudiger Kurtz, Heidenheim (DE); Alfred Bubik, Ravensburg (DE)

Correspondence Address: GREENBLUM & BERNSTEIN, P.L.C., 1950 ROLAND CLARKE PLACE, RESTON, VA, 20191, US

(73) Assignee: Voith Paper Patent GmbH, Heidenheim (DE)

(21) Appl. No.: 10/619,424

(22) Filed: Jul. 16, 2003

(30) Foreign Application Priority Data
Jul. 18, 2002 (DE) 102 32 550.2

(51) Int. Cl. B05D 3/12; B05C 1/00

(52) U.S. Cl. 427/299; 427/355; 118/200; 118/235

(57) ABSTRACT

Device and process for impregnating web with an impregnating agent. The device includes a coating device structured and arranged to apply the impregnating agent to the web and a wide nip calender located, with respect to a web travel direction, before the coating device. The wide nip calender includes a circulating jacket and a back pressure element arranged to form a wide nip. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 102 32 550.2, filed on Jul. 18, 2002, the disclosure of which is expressly incorporated by reference herein in its entirety.

### BACKGROUND OF THE INVENTION

1. Field of the Invention

The invention relates to a device for impregnating a paper or cardboard web with a basis weight of over 40 g/m². A web travel path is provided in the device so that an impregnating agent, such as a starch solution, so-called “starch size,” or other coating agent commonly used in paper upgrading, can be applied to the web. The invention further relates to a process for impregnating a paper or cardboard web with an impregnating agent, such as a starch solution, so-called “starch size,” or other coating agents commonly used in paper upgrading, such that the impregnating agent is pressed completely or partly into the web.

2. Discussion of Background Information

Paper or cardboard webs are made chiefly of cellulose fiber. They therefore exhibit a polar, highly hydrophilic character, i.e., they can easily be wetted and swollen by water. In order to prevent or limit the uncontrolled penetration by water or other polar liquids into the open-pored fiber structure, some paper or cardboard types are “sized,” i.e., at least partly hydrophobized by the addition of a liquid impregnating agent, such as starch size, also known as “size” for short, or other coating agents commonly used in paper upgrading. Moreover, impregnating has the advantage that the strength of the web is increased.

When impregnating with size or other coating agents commonly used in paper upgrading, the object is to have the size soak the web as fully as possible, so that the web is completely “filled.” As a rule this is possible with thinner papers with a basis weight of up to 80 g/m² in a relatively easy manner by running the web through a so-called “size press” with a size or starch bath and by compressing it in the nip after soaking, thereby pressing the size into the web. Another possibility is to have the web run through a so-called “film press.” As a result of the compression stresses acting in the nip, the size penetrates into the web. However, with thicker paper or cardboard webs with a basis weight of 90 g/m² or more, with otherwise unchanged conditions, this approach means the size is pressed only into certain surface areas, particularly with film presses, so that the web is not completely soaked. Such a web that is not completely soaked has, e.g., reduced strength properties compared with a web completely acted upon.

Although, theoretically, the pressure in the nip could be increased to press the size into deeper areas of the web as well, a higher pressure has the disadvantage that it is associated with a loss of volume in the web. This in turn leads to a lower thickness of the web and thus consequently to a weakening or reduction in strength. In order to compensate for this disadvantage, it would be necessary to use more material, which in turn would lead to a higher basis weight of the cardboard web. With cardboard webs the aim is to achieve on the one hand a high strength and on the other hand as low a basis weight as possible.

### SUMMARY OF THE INVENTION

The present invention improves the impregnation of the paper or cardboard web without having to tolerate a greater loss of volume.

According to the invention, a device of the type mentioned at the outset further includes a wide nip calender arranged in the web travel path before the coating device, in which a wide nip is formed by a circulating jacket and a back pressure element interacting with it and through which the web travel path is guided.

It is assumed that the web is somewhat compressed in the wide nip. If the web is compressed and then inserted into the coating device, it becomes completely “soaked” with impregnating agent. This is attributed to the fact that the capillary action is increased through the compression of the fibers so that the transport of the impregnating agent applied in liquid form into the web is improved. The wide nip calender has the advantage that an elastic compression can be achieved, i.e., relatively small compression stresses are sufficient. The forces fed into the wide nip are distributed over a relatively large area, resulting in an effect with low volume stressing. The jacket of the wide nip calender should feature a certain resilience so that it can adapt to the shape of the back pressure element, e.g., an opposing roll. This resilience has another advantage. It ensures that the web is not squeezed in the wide nip. No structures are therefore destroyed, even locally. The web is evenly compressed in the wide nip, i.e., even flock areas are not over-pressed, but are compressed homogenously with adjacent areas on which no such fiber accumulations have formed. Since the web is compressed uniformly everywhere, the same capillary action also occurs everywhere, i.e., the impregnating agent is absorbed uniformly over the entire surface of the web. This results in a higher rigidity of the web, a higher strength, e.g., tear strength, an improved burst strength and a favorable angle of incline with cardboard webs, i.e., the surface roughness is great enough for cardboards resting on top of one another not to slip. These advantages are otherwise only achieved with more mass, i.e., a higher basis weight, which in turn entails increased costs.

No other processing device is preferably arranged between the wide nip and the coating device, apart from guide devices that may be present. The web therefore comes out of the wide nip and runs directly into the coating device. Although it can be deflected and, if necessary, also spread out in between, a processing in the sense of influencing the web or its structure does not take place.

This approach has the advantage that the compression, even if it is only temporary, is still present when the web enters the coating device. There the web can become saturated with the impregnating agent, whereby the coating can, of course, still also be aided by exerting a certain pressure from outside.

The wide nip preferably features a heating device. The heating device has two advantages, i.e., the surface properties of the web are improved, and the penetration of the liquid impregnating agent into the web is aided by an increased temperature of the web. Thus, the capillary action is improved.

The heating device is preferably formed by the back pressure element. This is a relatively simple way of feeding the required thermal energy into the wide nip, or to be more precise, of transferring it to the web.

It is hereby preferred for the heating device to feature a surface limiting the web travel path in the wide nip and the temperature of this surface is adjustable to 200° C. or higher. If the web in the wide nip is heated to such a high temperature, in the following coating device, the web will still have a temperature that is high enough to aid the penetration of the impregnating agent into the web. However, the temperature of the web in the coating device is thereby as a rule lower than 100° C., so there is no danger that the impregnating agent liquid will begin to boil.

The coating device is preferably embodied as a film press. The use of a film press as opposed to a size press has the advantage that higher speeds can be used. The film press, which is also called a “speed sizer,” is provided with a film of the liquid impregnating agent and transfers this film in a nip to the paper or cardboard web. The film press thus generates a contour application of the liquid impregnating agent on the surface of the paper or cardboard web. This produces a particularly advantageous interaction with the wide nip, where a contour glazing, thus a homogenous processing, takes place. A uniform density of the web is produced in the wide nip, whereas producing a uniform thickness is of lesser importance.

In a preferred embodiment it is provided for a drying area to be arranged downstream of the coating device, whereby the temperature in the wide nip is higher than the temperature in the drying area. In particular the temperature in the drying area should be lower than the plasticizing temperature of the fibers of the web. The surface of the web is therefore not changed to an appreciable extent in the drying area.

The temperature in the wide nip is preferably adjustable at least to the plasticizing temperature of the fibers of the paper or cardboard web. This means that the surface of the web can be closed in the wide nip. The closing creates a smooth surface of the web without preventing the penetration of the impregnating agent liquid. The impregnating agent can still penetrate inside the web due to the capillary action. This applies above all when the impregnating agent application is aided by a pressure effect from outside, e.g., through the film press or a size press.

Through the higher temperature in the wide nip, at which the fibers of the web are plasticized at least on the surface, it is ensured that the fibers can no longer stand up after leaving the wide nip. Therefore, there is overall a smoother surface on which the impregnating agent can be applied in a more uniform way.

No glazing device is preferably arranged between the coating device and a downstream reeling device for the reasons given. Glazing device should hereby also mean both a machine calender with two hard rolls and another two- or multi-roll machine in which at least one roll features an elastic or resilient surface. The paper or cardboard web is already given such a smooth surface through the use of the wide nip calender that a subsequent glazing is often no longer necessary.

Surprisingly, it has turned out that papers and cardboards of stone groundwood, mechanical pulp and thermomechanical pulp actually “expand” during final drying in the device according to the invention (wide nip glazing, size coating, drying). In other words, these papers or cardboards even increase in thickness and volume after the coating device, while the achieved surface smoothness is retained

The present invention provides with a process of the type mentioned at the outset that further includes that the web is acted on with pressure in a wide nip before the application of the impregnating agent. The pressure is generated by interaction between a circulating jacket and a back pressure element.

As noted above, the web is somewhat compressed in the wide nip, which results in the occurrence of excellent capillary action during the downstream application of the impregnating agent. In this manner, the web is saturated with the impregnating agent, whereby the application and the penetration of the impregnating agent can of course be intensified by outside pressures, such as can be exerted by interacting rolls. However, such pressures can be kept much lower so that the loss of volume of the web during the application of the impregnating agent can be kept smaller. Although a certain loss of volume through the treatment in the wide nip is tolerated, this loss of volume can be kept extraordinarily low. Through the large impact surface of the web in the wide nip it is possible to adjust the compression of the web with great precision, such that the compression stresses that act on the web in the wide nip can be kept relatively small.

The web is preferably heated in the wide nip. As stated above, heating has two advantages. A warmer web has an improved capillary action, i.e., the liquid impregnating agent can be more easily absorbed, thus penetrating inside the web. In addition, the web in the wide nip is glazed to a certain extent so that the impregnating agent can be applied on a smoother surface, which in turn improves the uniformity of the application.

The impregnating agent is preferably applied in a contour application. To this end, e.g., a film press can be used. Since a contour glazing takes place in the wide nip, the contour application of the impregnating agent adapts to the preceding treatment of the web in a favorable manner.

The present invention is directed to a device for impregnating web with an impregnating agent. The device includes a coating device structured and arranged to apply the impregnating agent to the web and a wide nip calender located, with respect to a web travel direction, before the coating device. The wide nip calender includes a circulating jacket and a back pressure element arranged to form a wide nip.

According to a feature of the invention, the impregnating agent may include a starch solution or other coating agents commonly used in paper upgrading. The starch solution can be a starch size. Further, the web can be one of a paper or cardboard web.

In accordance with another feature of the present invention, the impregnating agent can be applied to a web having a basis weight over 40 g/m².

Further, between the wide nip and the coating device, no other web processing devices are provided. However, at least one guide device can be arranged between the wide nip and the coating device.

The wide nip calender can further include a heating device, and the heating device can be formed by the back pressure element. Moreover, the heating device may include a surface structured to guide the web through the wide nip, and the surface can have a temperature adjustable to at least 200° C.

In accordance with the present invention, the coating device can include a film press.

Further, a drying area may be located downstream of the coating device. The wide nip can be heated to a temperature higher than a temperature in the drying area.

According to still another feature of the invention, the wide nip may be adjustably heated to at least a plasticizing temperature of web fibers of the web.

Still further, a reeling device can be arranged downstream of the coating device, and no glazing device is arranged between the coating device and the reeling device.

The present invention is directed to a process for impregnating web with an impregnating agent. The process includes applying the impregnating agent to the web, and, before the applying of the impregnating agent, pressing the web in a wide nip formed between a circulating jacket and a back pressure element.

According to a feature of the present invention, the process can further include pressing the impregnating agent into the web at a location downstream of the wide nip. Moreover, the impregnating agent can be pressed into the web by an application device for the impregnating agent.

According to another feature of the instant invention, the process can also include heating the web in the wide nip. Further, the web can be heated in the wide nip to a temperature sufficient to plasticize web fibers of the web.

In accordance with still another feature of the invention, the impregnating agent may be applied in a contour coating.

The present invention is directed to a process of impregnating a web with an impregnating agent. The process includes pressing the web in a wide nip, and drawing impregnating agent into the web, downstream of the wide nip relative to a web travel direction, via capillary action of the web.

According to a feature of the invention, the process can further include pressing the impregnating agent into the web downstream of the wide nip.

Moreover, the process can include plasticizing web fibers of the web in the wide nip.

In accordance with still another feature of the invention, the process may include heating the web in the wide nip at a temperature greater than in a dryer section located downstream of the wide nip.

According to still another feature of the instant invention, the web can be pressed in the wide nip to produce a uniform web density.

In accordance with still yet another feature of the present invention, the impregnating agent may be applied to a web having a basis weight over 40 g/m², and preferably, the impregnating agent is applied to a web having a basis weight over 90 g/m².

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates a paper machine in accordance with the features of the invention;

FIG. 2 illustrates an enlarged section with a wide nip calender and a film press depicted in FIG. 1; and

FIG. 3 illustrates an enlarged representation of a section of a paper or cardboard web acted on in accordance with the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

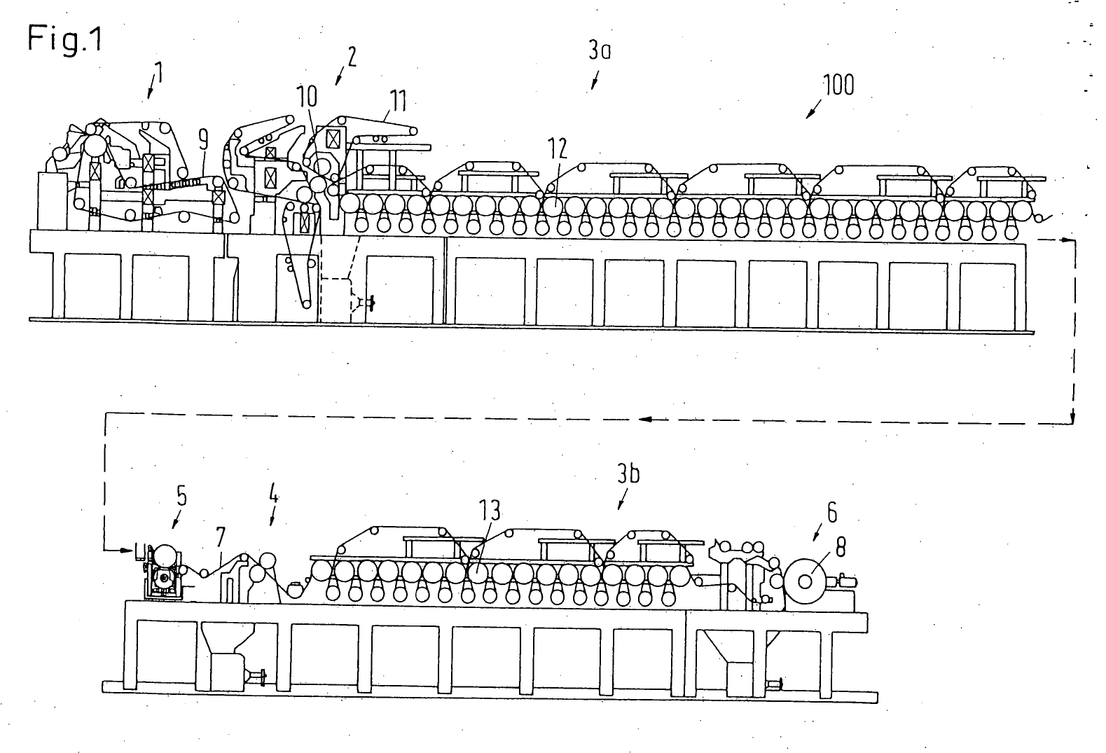

FIG. 1 shows diagrammatically a paper machine 100 with a wire section 1, a press section 2, a drying section, divided into two parts 3a and 3b, and, between parts 3a and 3b of the drying section, a coating device 4 for an impregnating agent, such as a starch solution, so-called “starch size,” or other coating agents commonly used in paper upgrading, e.g., an aqueous pigment dispersion, with an upstream wide nip calender 5. A reeling device 6 is arranged behind the second part of drying section 3b, in which reeling device a paper or cardboard web 7 is reeled up into a wound reel 8. It should be noted that no glazing device is arranged between coating device 4 and reeling device 6, i.e., web 7 is already provided with such a surface smoothness in wide nip calender 5 and the following coating device that further glazing is not necessary.

The mode of operation of the paper machine is known per se and will therefore be explained only briefly. In wire section 1 liquid pulp with a solids content in the range of 1% is applied to a wire 9. The liquid flows off through the wire 9 so that the web can run into press section 2 with a solids content of approx. 20%. Various press nips are embodied in press section 2 through which the paper or cardboard web runs together with a felt web 11. In press nips 10 more water is pressed out of web 7 and transferred to felt webs 11. After running through press section 2, web 7 arrives in drying section 3a where it is guided over a plurality of drying cylinders 12. Drying cylinders 12 are heated, preferably by steam, so that further moisture is evaporated from web 7. After first part 3a of the drying section, web 7 is guided through wide nip calender 5 and subsequently through coating device 4. Afterwards, web 7 is dried in second section 3b of the drying section, where further heated drying cylinders 13 are provided to evaporate liquid from web 7.

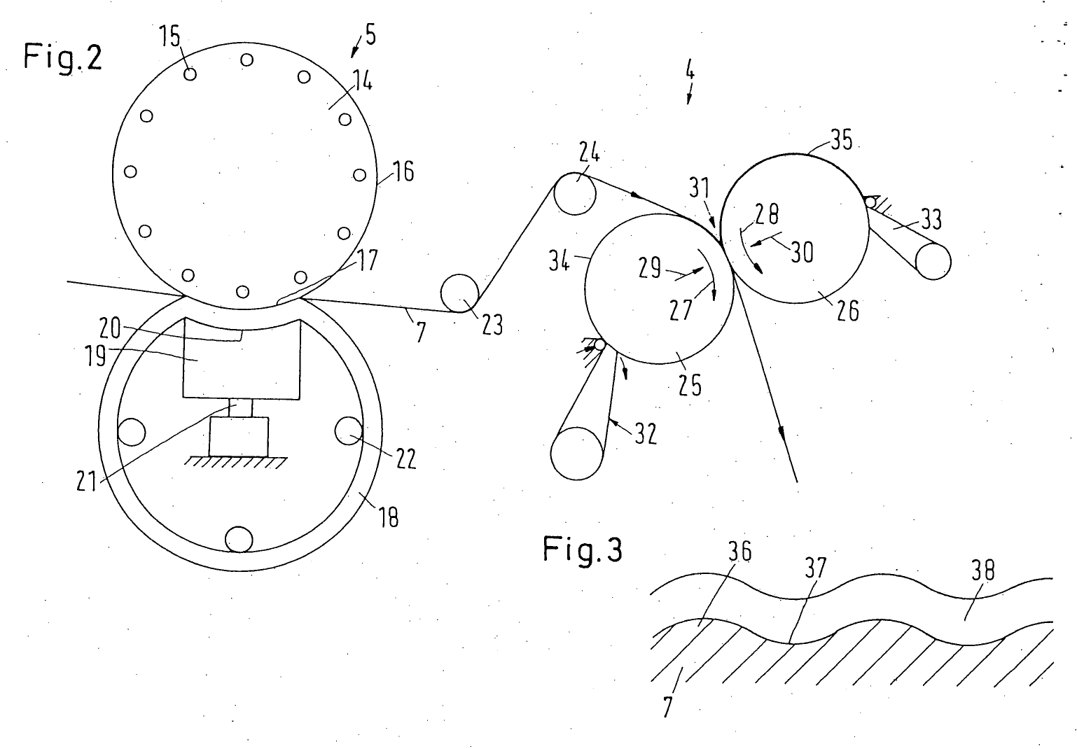

FIG. 2 shows an enlarged section of the paper machine with coating device 4 and wide nip calender 5.

Wide nip calender 5 is formed by a heated opposing roll 14 that is provided with heating channels 15, through which a hot liquid or another heating medium can be guided, in order to heat opposing roll 14. Opposing roll 14 is heated such that its surface 16 attains a temperature of at least 200° C. The temperature of surface 16 should be high enough that the web fibers of web 7 are plasticized at least in the area of their surface.

Opposing roll 14 and circulating jacket 18 are arranged to form a wide nip 17 as press-down shoe 19 presses circulating jacket 18 against circumferential surface 16 of opposing roll 14. In this manner, at least a portion of a circumferential surface of circulating jacket 18 is arranged to wind around or over circumferential surface 16 of opposing roll 14. However, it is noted that jacket 18 does not rest directly on surface 16 of opposing roll 14 because web 7 is arranged as an intermediate layer. Press-down shoe 19 features a contact surface 20 having a curvature adapted to a curvature of surface 16 of the opposing roll 14, so as to delimit or define the wide nip. In a manner not shown in further detail, but known per se, contact surface 20 is lubricated, e.g., hydrostatically or hydrodynamically. Further, press-down shoe 19 can be acted on with a force via a piston-cylinder device 21 so that a certain compression stress can be produced in wide nip 17. However, the compression stress in wide nip 17 is relatively small compared to a compression stress that would exist in a nip between two rolls with otherwise unchanged force conditions.

As shown, circulating jacket 18 can be relatively rigid and circulate in the manner of a roll shell. In the exemplary embodiment, circulating jacket 18 is supported by reels 22. However, circulating jacket 18 can also be embodied to be relatively thin so that it circulates in the manner of a belt. Nevertheless, in both cases circulating jacket 18 should be structured to be somewhat resilient.

Wide nip 17 features a relatively large length in the travel direction of web 7, preferably between 50 and 700 mm. It is therefore possible to adjust the compression stresses in wide nip 17 in a relatively sensitive manner.

Web 7 is guided over guide rolls 23 and 24 to coating device 4 that is embodied or formed in the present case as a film press or “speed sizer.”

In the exemplary embodiment, coating device 4 includes two rolls 25 and 26 that are arranged to rotate in the directions of arrows 27 and 28 and that are pressed together in the direction of arrows 29 and 30 to form a nip 31, through which web 7 is guided. Moreover, web 7 can be acted upon with a certain pressure in nip 31 due to the pressing action depicted by arrows 29 and 30. However, it is noted that other coating devices can be utilized without departing from the scope and spirit of the instant invention.

Each roll 25 and 26 is provided with an impregnating agent dispenser 32 and 33 that applies an impregnating agent film 34 and 35 onto the surface of rolls 25 and 26. Impregnating agent film 34 and 35 is adjusted so that the impregnating agent can be absorbed virtually completely by web 7.

Web 7 is somewhat compressed in wide nip 17. However, this compression does not take place for the purpose of producing a uniform thickness across the width of the web 7. Instead, the pressurization of web 7 in wide nip 17 is performed to produce a uniform density. Thus, the pressurization is limited such that flock areas are not crushed. As a result, local thickenings of web 7 are retained, as illustrated in FIG. 3, which depicts a part of a cross-sectional view of web 7, in which elevations 36 are discernible, which alternate with troughs 37. Therefore, the compression (glazing) in wide nip 17 is a contour glazing.

The compression in wide nip 17 is adjusted so that web 7 develops an intensified capillary action in nip 31 of coating device 4. Therefore, the impregnating agent from impregnating agent films 34 and 35 is not merely fed into web 7 by pressures 29 and 30 in nip 31. Instead, the impregnating agent feed is additionally aided by the fact that the impregnating agent is absorbed by the capillary action of web 7 so as to penetrate into web 7 much more quickly and deeply than would be possible merely with the aid of the pressurization. Through the improved penetration of web 7 with impregnating agent, thicker webs 7, i.e., webs with larger basis weights, e.g., 90 g/m² or more, can be completely soaked with impregnating agent without a greater loss of volume having to be tolerated. Although a certain loss of volume in wide nip 17 is inevitable, this loss of volume is relatively small due to the relatively low compression stresses in wide nip 17.

In addition, the capillary action can be aided by heating web 7 with the aid of opposing roll 14. Within certain limits, the capillary action improves with an increase in temperature. However, it should be ensured that the temperature of web 7 in nip 31 of coating device 4 remains under 100° C. in order to prevent the liquid impregnating agent from boiling.

The temperature of opposing roll 14 is preferably adjusted so that the fibers of web 7 are plasticized in wide nip 17. Thus, the fibers are shaped such that they can no longer stand up again, which also improves the ability of web 7 to absorb impregnating agent in nip 31, because web 7 can then rest with more of its surface on rolls 25 and 26.

Coating device 4, e.g., embodied or formed as a film press, produces a contour coating of the impregnating agent on the surface of web 7, which is likewise discernible from FIG. 3, as layer 38. Layer 38 is shown diagrammatically there, symbolizing the applied impregnating agent. It is discernible that this layer 38 features essentially the same thickness throughout.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A device for impregnating web with an impregnating agent, comprising:
a coating device structured and arranged to apply the impregnating agent to the web; and
a wide nip calender located, with respect to a web travel direction, before said coating device, said wide nip calender comprising a circulating jacket and a back pressure element arranged to form a wide nip.

2. The device in accordance with claim 1, wherein the impregnating agent comprises a starch solution or other coating agents commonly used in paper upgrading.

3. The device in accordance with claim 2, wherein the starch solution comprises a starch size.

4. The device in accordance with claim 2, wherein the web comprises one of a paper or cardboard web.

5. The device in accordance with claim 1, wherein the impregnating agent is applied to a web having a basis weight over 40 g/m².

6. The device in accordance with claim 1, wherein, between said wide nip and said coating device, no other web processing devices are provided.

7. The device in accordance with claim 6, wherein at least one guide device is arranged between said wide nip and said coating device.

8. The device in accordance with claim 1, wherein said wide nip calender further comprises a heating device.

9. The device in accordance with claim 8, wherein said heating device is formed by said back pressure element.

10. The device in accordance with claim 8, wherein said heating device comprises a surface structured to guide the web through said wide nip, and said surface having a temperature adjustable to at least 200° C.

11. The device in accordance with claim 1, wherein said coating device comprises a film press.

12. The device in accordance with claim 1, further comprising a drying area located downstream of said coating device.

13. The device in accordance with claim 12, wherein said wide nip is heated to a temperature higher than a temperature in said drying area.

14. The device in accordance with claim 1, wherein said wide nip is adjustably heated to at least a plasticizing temperature of web fibers of the web.

15. The device in accordance with claim 1, further comprising a reeling device arranged downstream of said coating device, wherein no glazing device is arranged between said coating device and said reeling device.

16. A process for impregnating web with an impregnating agent, comprising:
applying the impregnating agent to the web;
before the applying of the impregnating agent, pressing the web in a wide nip formed between a circulating jacket and a back pressure element.

17. The process in accordance with claim 16, wherein the impregnating agent comprises a starch solution or other coating agents commonly used in paper upgrading.

18. The process in accordance with claim 17, wherein the starch solution comprises a starch size.

19. The process in accordance with claim 17, wherein the web comprises one of a paper or cardboard web.

20. The process in accordance with claim 16, wherein the impregnating agent is applied to a web having a basis weight over 40 g/m².

21. The process in accordance with claim 16, further comprising pressing the impregnating agent into the web at a location downstream of the wide nip.

22. The process in accordance with claim 21, wherein the impregnating agent is pressed into the web by an application device for the impregnating agent.

23. The process in accordance with claim 16, further comprising heating the web in the wide nip.

24. The process in accordance with claim 23, wherein the web is heated in the wide nip to a temperature sufficient to plasticize web fibers of the web.

25. The process in accordance with claim 16, wherein the impregnating agent is applied in a contour coating.

26. A process of impregnating a web with an impregnating agent, comprising:
pressing the web in a wide nip; and
drawing impregnating agent into the web, downstream of the wide nip relative to a web travel direction, via capillary action of the web.

27. The process in accordance with claim 26, further comprising pressing the impregnating agent into the web downstream of the wide nip.

28. The process in accordance with claim 26, further comprising plasticizing web fibers of the web in the wide nip.

29. The process in accordance with claim 26, further comprising heating the web in the wide nip at a temperature greater than in a dryer section located downstream of the wide nip.

30. The process in accordance with claim 26, wherein the web is pressed in the wide nip to produce a uniform web density.

31. The process in accordance with claim 26, wherein the impregnating agent is applied to a web having a basis weight over 40 g/m².

32. The process in accordance with claim 31, wherein the impregnating agent is applied to a web having a basis weight over 90 g/m².
